(19) United States
(12) Patent Application Publication
(10) Pub. No.: US 2022/0034334 A1
(43) Pub. Date: Feb. 3, 2022

(54) BELLOWS ACCUMULATOR

(71) Applicant: HYDAC TECHNOLOGY GMBH, Sulzbach/Saar (DE)

(72) Inventors: Herbert BALTES, Losheim (DE); Peter KLOFT, Ransbach-Baumbach (DE)

(21) Appl. No.: 17/275,745

(22) PCT Filed: Sep. 9, 2019
(86) PCT No.: PCT/EP2019/073918

§ 371 Date: Mar. 12, 2021

(30) Foreign Application Priority Data
Sep. 14, 2018 (DE) 10 2018 007 279.8

(51) Int. Cl. F15B 1/10

(52) U.S. Cl. CPC F15B 1/103; F15B 2201/205; F15B 2201/4056; F15B 2201/3157; F15B 2201/3158; F15B 2201/3153

(57) ABSTRACT

A bellows accumulator, consisting of at least one accumulator housing (2) and having a separating bellows (20) which is movably arranged in the accumulator housing (2) and has a plurality of bellows folds and separates two media spaces (8, 22) from one another, wherein the stationary open end of said separating bellows (20) is fixed to the accumulator housing (2) by means of a securing device (24) and wherein said separating bellows (20) has at its movable other end a closure part (36) having a guide device (40) by means of which the closure part (36) is guided in the accumulator housing (2), is characterized in that the closure part (36) has, in addition to the guide device (40), a sealing device which, at least in the one extended end position of the separating bellows (20), separates a fluid space (8), in which the bellows folds are arranged in the accumulator housing (2), from a fluid port (12) in the accumulator housing (2) and, at least in some of the other working positions, releases this fluid connection.

The invention relates to a bellows accumulator, consisting of at least one accumulator housing and having a separating bellows, which is movably arranged in the accumulator housing and has a plurality of bellows folds and separates two media spaces from each other, wherein the stationary open end of said separating bellows is fixed to the accumulator housing by means of a securing device and wherein said separating bellows has, at its movable other end, a closure part having a guide device, which is used to guide the closure part in the accumulator housing.

Bellows accumulators of this type are state of the art, see for instance DE 10 2015 012 253 A1. Bellows accumulators are advantageously used in hydraulic systems, preferably to reduce or smooth pressure peaks occurring in pressure fluids. To ensure that the separating bellows during operation can move freely and without the risk of damage into its respective working positions, the outer diameter of a bellows is selected to be slightly smaller than the inner diameter of the accumulator housing, and the guide device of the closure part is used to guide the bellows such that a gap is formed between the tips of the bellows and the housing wall in the working positions. This gap forms a part of the media chamber of the liquid side and, in operation, is pressurized with the fluid pressure applied from one fluid port, while the inside of the bellows, from its open end, is pressurized with the pre-fill pressure existing in the other media chamber. During operation, the pressure balance between the liquid pressure acting in the gap and the pre-fill pressure prevents the bellows from being pressed against the inner wall of the housing and being damaged. However, this is different in operating states, in which the liquid side is depressurized or the liquid pressure drops below the pre-fill pressure. Because of the pressure present in the bellows' interior, when the gap is depressurized or only slightly pressurized, the tips of the bellows are pressed against the inner wall of the housing and damaged thereby.

With regard to this problem, the invention addresses the problem of providing a bellows accumulator of the genus mentioned above, which is characterized by a high degree of operational reliability compared to the prior art.

According to the invention, this problem is solved by a bellows accumulator having the features of claim 1 in its entirety.

According to the characterizing part of claim 1, an essential feature of the invention is that the closure part has, in addition to the guide device, a sealing device which, at least in the one extended end position of the separating bellows, separates a fluid space, in which the bellows folds are arranged in the accumulator housing, from a fluid port in the accumulator housing and releases this fluid connection, at least in some of the other working positions. In this way, in operation when the fluid connection is released, the mode of operation of the bellows accumulator according to the invention equals that of the known bellows accumulator mentioned, as long as the bellows is not in the extended end position and the pressure between the fluid chamber in the gap and the bellows interior is balanced.

As soon as the bellows reaches its extended end position because of a predominant pre-fill pressure, the sealing device of the guide unit blocks the fluid chamber on the outside of the bellows. The enclosed fluid volume supports the bellows against the pre-fill pressure acting from the interior and the bellows is thereby protected against damage at pressure ratios, where the pre-fill pressure is greater than the liquid pressure. If temperature changes occur in the operating state, in which the liquid volume in the gap is enclosed by the sealing device, with a resulting expansion or contraction of the fluid volume corresponding to the coefficient of thermal expansion, this may cause a deformation of the bellows. To keep this deformation and accordingly the stresses in the bellows below a threshold value, which could negatively affect the service life of the bellows, the gap width and accordingly the enclosed liquid volume are set to a small size. As stated in the prior art document DE 10 2015 012 253 A1 cited, the gap dimension in bellows accumulators of this type can be smaller than 1 mm. In such small liquid volumes, temperature changes are not critical even across a wide range. The bellows accumulator according to the invention can therefore also be used advantageously in aerospace applications where high temperature differences must be safely controlled.

Advantageously, the sealing device on the closure part can be set back reduced in the diameter from the guide device. At the housing side, a housing wall part reducing the inner diameter of the housing and forming a sealing surface can be provided for interaction with the sealing device having a reduced diameter.

In advantageous exemplary embodiments, the closure part has a dome at its end facing the fluid port, wherein in the area of the fluid port (12) the convex outer contour of said dome follows the inner contour of the accumulator housing and is brought at least partially into contact with the latter in one end position. Thus in the end position practically no fluid dead volume remains in the area of the accumulator housing adjacent to the fluid port.

Advantageously, a shoulder is formed on the inside of the accumulator housing, wherein against said shoulder the separating bellows moves in its one end position, closing the port.

Advantageously, the arrangement can be made in such a way that the shoulder is provided with a slope which tapers in the direction of the port and forms a blocked fluid transition between the guide device and the sealing device in the one end position that closes the port. At this the conical surface can form a ramp, up which the sealing device runs onto a projecting sealing surface of the accumulator housing when the end position is reached.

In advantageous exemplary embodiments, the guide device of the closure part has a guide ring having individual guide segments, which are in contact with the inner wall of the accumulator housing in every working position of the separation bellows and delimit passage spaces for fluid therebetween. When the bellows is in the working positions, the fluid chamber on the outside of the bellows is connected to the fluid port via the passage spaces of the guide ring.

The outer diameter of the bellows folds can advantageously be selected to be slightly smaller than the assignable inner diameter of the accumulator housing such that in the fluid space partial spaces are formed, which in their entirety form a hydraulic damping of the fluid.

The sealing device can advantageously be arranged on the closure part between the guide device and the dome.

Advantageously, the arrangement is further such that in the end position of the separating bellows opposite from the one end position the bellows folds are in full contact with one another.

In the manner known per se for bellows accumulators, the accumulator housing can be wrapped to increase its resistance to pressure. Such a wrap, technically known as a liner, can be formed from a glass fiber composite.

The invention is explained in detail below, with reference to an exemplary embodiment shown in the drawing. In the Figures:

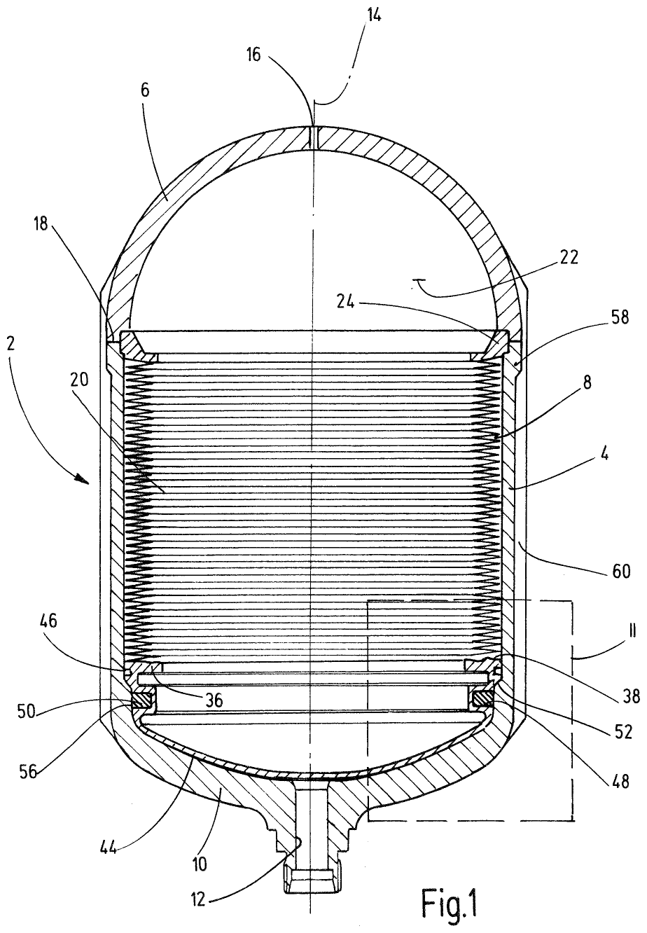

FIG. 1 shows a longitudinal section of the exemplary embodiment of the bellows accumulator according to the invention; and

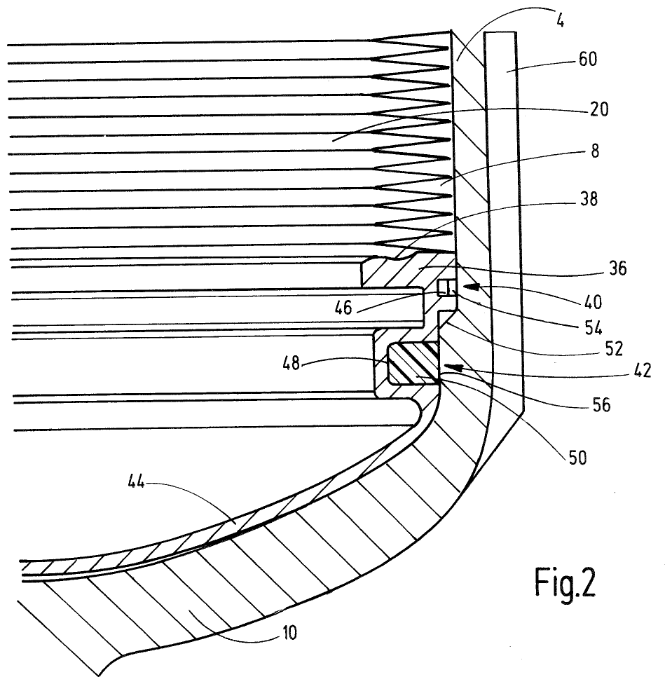

FIG. 2 shows an enlarged partial longitudinal section of the area designated II in FIG. 1.

The exemplary embodiment of the bellows accumulator according to the invention shown in FIG. 1 has an accumulator housing designated as a whole by 2, which has two housing parts, one of which forms a main housing part designated by 4 and the other forms a housing closing part designated by 6. The main part 4 has the form of a pot having a circular-cylindrical interior 8 and a dome-shaped pot bottom 10, which is closed except for a fluid port 12 coaxial with the longitudinal axis 14. The closing part 6 is shaped like a semispherical bowl, which is closed except for a filling opening 16 coaxial with the axis 14. The main part 4 and the closing part 6 are welded together along their end rims facing each other at a weld line 18. A separating bellows in the form of a metallic bellows 20 is accommodated in the circular cylindrical interior 8 between the weld line 18 and the pot bottom 10. As is common with bellows for bellows accumulators, the bellows 20 is made of a stainless steel, wherein in the present example a chromium-nickel-molybdenum steel alloy (AM350) is provided. At its end at the top in FIG. 1, at which the bellows 20 is open to the gas end 22, adjacent to the filling opening, of the accumulator housing 2, the last bellows side of the bellows 20 is welded to a retaining ring 24, which forms the securing device used to fix the immovable bellows end of the bellows 20 to the accumulator housing 2. The retaining ring 24 is formed of stainless steel, for instance steel 1.4435, and is welded to the housing parts 4 and 6 at the weld line 18 by means of laser welding.

At its other, movable free end, which is opposite from the open bellows end connected to the retaining ring 24, the interior of the bellows 20, which is open towards the gas end 22, is closed by a closure part 36 made of stainless steel (such as steel 1.4435), which is firmly welded to the facing bellows end. The closure part 36 has the shape of a circular bowl, on the outer circumference of which, starting from the open rim of the bowl 38, a guide device 40 and a sealing device 42 adjoining it are formed, see FIG. 2. As can be seen most clearly from this figure, the guide device 40 has a circumferential annular groove 46 near the rim of the bowl 38, wherein in said annular groove 46 a guide ring in the form of a flat ring 54 is received. The sealing device 42 has an annular groove 48 that is offset axially from the annular groove 46 of the guide device 40 in the direction towards the pot bottom 10 and radially inwards. A gasket 50 is received in the annular groove 48. At the underside adjoining the lower annular groove 48, the closure part 36 is closed by a dome part 44.

The flat ring 54, forming the guide ring of the guide device 40, in the annular groove 46 has the function of guiding the bellows folds along the inner wall during movements out of the end position shown in FIGS. 1 and 2 while maintaining a gap in the interior 8 between the tips of the bellows and the housing wall. For this purpose, the guide ring is made of a plastic having good sliding properties, such as polytetrafluoroethylene, as shown in FIGS. 5 and 6 of EP 2 519 748 B1. To form passage spaces at the circumference of the flat ring 54 to permit fluid to pass from the fluid port 12 into the interior 8 surrounding the bellows 20, recessed areas are formed as passage spaces at the circumference of the flat ring 54 between guide bodies abutting the housing wall as guide shoes. In operation, therefore, the interior 8, surrounding the bellows 20, forms a part of the fluid side. When the bellows 20 is not fully compressed, the spaces between the bellows folds form damping spaces as part of the fluid side, wherein the volumes of said spaces change correspondingly during the bellows movements in operation, wherein one damping throttle each is formed between every tip of the folds and the inner wall of the housing, wherein the selected gap dimension between the inner wall of the main part 4 and the tips of the bellows determines the throttle cross-section.

As is most clearly shown in FIG. 2, a shoulder is formed at the transition between the main housing part 4 and the pot bottom 10, wherein up against said shoulder the closure part 36 of the bellows 20 runs when in the extended end position. The shoulder is provided with a slope, which tapers in the direction of the fluid port 12, thereby forming a ramp surface 52, which the gasket 50 of the sealing device 42 traverses during movement into the end position and where the gasket comes into contact with a sealing surface 56 formed by a radially inwardly offset, circular cylindrical wall part of the accumulator housing. As a result, in the end position shown in the figures, the fluid connection between the fluid port 12 and the interior 8 is blocked, such that the volume of fluid, located in the gap of the interior 8, is enclosed as long as the bellows is in its extended end position. In the working positions, in which the gasket 50 has left the sealing surface 56, the fluid connection between the fluid port 12 and the gap in the interior 8 is opened for normal operation.

As shown in FIG. 1, the main housing part 4 has, starting from a thickened wall part 58 adjoining to the weld line 18, an area of reduced wall thickness extending to the area of the pot bottom 10. As indicated in FIG. 1, this area has a fiber wrap 60 of fiberglass material extending beyond the weld line 18 up to the beginning area of the housing part 6. The fiber wrap 60, increasing the compressive strength, with regard to their structure corresponds to the wraps known by the technical name “liner” in pressure vessels.

1. A bellows accumulator, consisting of at least one accumulator housing (2) and having a separating bellows (20), which is movably arranged in the accumulator housing (2) and has a plurality of bellows folds and separates two media spaces (8, 22) from each other, wherein the stationary open end of said separating bellows (20) is fixed to the accumulator housing (2) by means of a securing device (24) and wherein said separating bellows (20) has, at its movable other end, a closure part (36) having a guide device (40), which is used to guide the closure part (36) in the accumulator housing (2), characterized in that the closure part (36) has, in addition to the guide device (40), a sealing device which, at least in the one extended end position of the separating bellows (20), separates a fluid space (8), in which the bellows folds are arranged in the accumulator housing (2), from a fluid port (12) in the accumulator housing (2) and releases this fluid connection, at least in some of the other working positions.

2. The bellows accumulator according to claim 1, characterized in that the sealing device (42) on the closure part (36) is set back reduced in the diameter from the guide device (40).

3. The bellows accumulator according to claim 1, characterized in that the closure part (36) has a dome (44) at its end facing the fluid port (12), wherein in the area of the fluid port (12) the convex outer contour of said dome (44) follows the inner contour of the accumulator housing (2) and is brought at least partially into contact with the latter in one end position.

4. The bellows accumulator according to claim 1, characterized in that a shoulder (52) is formed on the inside of the accumulator housing (2), wherein against said shoulder (52) the separating bellows moves in its one end position, while closing the port.

5. The bellows accumulator according to claim 1, characterized in that the shoulder is provided with a slope (52) which tapers in the direction of the port (12) and forms a blocked fluid transition between the guide device (40) and the sealing device (42) in the one end position closing the port (12).

6. The bellows accumulator according to claim 1, characterized in that the guide device (40) of the closure part (36) has a guide ring (54) having individual guide segments, which are in contact with the inner wall of the accumulator housing (2) in every working position of the separating bellows (20) and delimit passage spaces for fluid therebetween.

7. The bellows accumulator according to claim 1, characterized in that the outer diameter of the bellows folds is selected to be slightly smaller than the assignable inner diameter of the accumulator housing (2) such that in the fluid space (8) partial spaces are formed which in their entirety form a hydraulic damping of the fluid.

8. The bellows accumulator according to claim 1, characterized in that the sealing device (42) is arranged between the guide device (40) and the dome (44) on the closure part (36).

9. The bellows accumulator according to claim 1, characterized in that in the end position of the separating bellows (20) opposite from the one end position, the bellows folds are in full contact with one another.

10. The bellows accumulator according to claim 1, characterized in that the accumulator housing (2) is wrapped to increase its resistance to pressure.
